(19) United States
(12) Patent Application Publication
(10) Pub. No.: US 2004/0143610 A1
(43) Pub. Date: Jul. 22, 2004

(54) Method for combining distributed databases

(76) Inventors: Karel Engelsmann, Munchen (DE); Hermine Schmid, Munchen (DE); Alfred Schneider, Haar (DE); Manfred Treichel, Germering (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/738,537

(22) Filed: Dec. 17, 2003

(30) Foreign Application Priority Data
Jun. 28, 2001 (EP) 01115830.0

(51) Int. Cl. G06F 17/30

(52) U.S. Cl. 707/204

(57) ABSTRACT

During generational change of exchanges, small relatively old exchanges (V2) previously working independently according to their own data banks (DBV2) are replaced by remote switching units (RSU). Said units are small independently working exchange and are assigned to central host exchanges (V), being controlled thereby, whereby data banks (DBV, neu) must be provided therein and the functionality thereof must include that of the data banks (DBV1, DBV2) of the previously separate exchanges (V1, V2). According to the invention, the data banks (DBV1, DBV2) are initially extracted from the exchanges (V1, V2), combined outside said exchanges and are subsequently completed with possible modifications of the original data banks (DBV1, DBV2). Said method runs automatically and allows planning data, for instance, to be incorporated. While the data banks (DBV1, DBV2) are being combined, operation remains substantially unimpeded to advantageous effect and read-only access to the old data banks (DBV1, DBV2) is possible. Several data banks can be combined by repeated application of the inventive method. The inventive method can also be used in other data processing systems, especially real-time systems.

During the change from one exchange generation to the next, smaller, older exchanges which previously operated independently using their own dedicated databases are replaced by remote switching units RSU (Remote Switching Unit). These remote switching units RSU are not independently operating exchanges. For this reason these switching units RSU are assigned to central host exchanges and controlled by these. Accordingly, in the central host exchange there must be databases present with functionality that includes the functionality of the databases of the previously separate exchanges.

A problem in connection with this generational change is to merge the databases of the exchanges to form a new database of the host exchange. Preferably this should take place largely without disruptions to ongoing operation. Conflicts caused by identical names in the old databases must be resolved. Because of the size of the databases it is likely that during the convergence of the databases, which preferably takes place outside of the switching systems, modifications will be made to the old databases still used in the exchanges. It is necessary that these modifications are also migrated to the new database.

This problem occurs not just when databases belonging to exchanges are combined; it also arises when databases of any real-time systems are merged. A method by means of which databases of real-time systems can be merged can also be applied in other—non-real-time—data processing systems.

The object underlying the present invention is to specify a method for merging distributed databases which solves in particular the problems referred to.

This object is achieved by the features of claim 1.

A significant advantage of the method according to the invention is that the merging of distributed databases takes place automatically outside of the data processing system while normal operation of the data processing system continues. Modifications to the old databases can continue to be made during the time that the merging operation is being performed and are incorporated into the new database using a log file generated while the modifications were being made. A requirement for this third step of the method is that the databases of the data processing system are locked for modifications during this step. However, because of the comparatively small amount of data to be processed the third step is executed without great time delays. During this time the data processing system can continue to be operated on the basis of the—now frozen—old databases.

It is particularly advantageous with this method that on the one hand the operation of the data processing system remains largely undisrupted during the merging of the databases. On the other hand, while the databases are being merged—second step of the method according to the invention—only read access is possible to the old databases of the data processing system, which continues to operate, so that regular operation with the old databases can be resumed without restrictions if the merging of the databases fails.

A further important advantage is that a plurality of databases can be merged by repeated application of the method according to the invention.

According to an advantageous embodiment of the inventive method a trial run of the automatic merger can be performed first. The identifiers assigned automatically during this trial run in the event of name conflicts can be viewed and modified. The resulting assignment list is then included in the actual merge.

Further advantageous embodiments of the invention can be inferred from the subclaims.

The method according to the invention is explained in more detail below with reference to four drawings, in which:

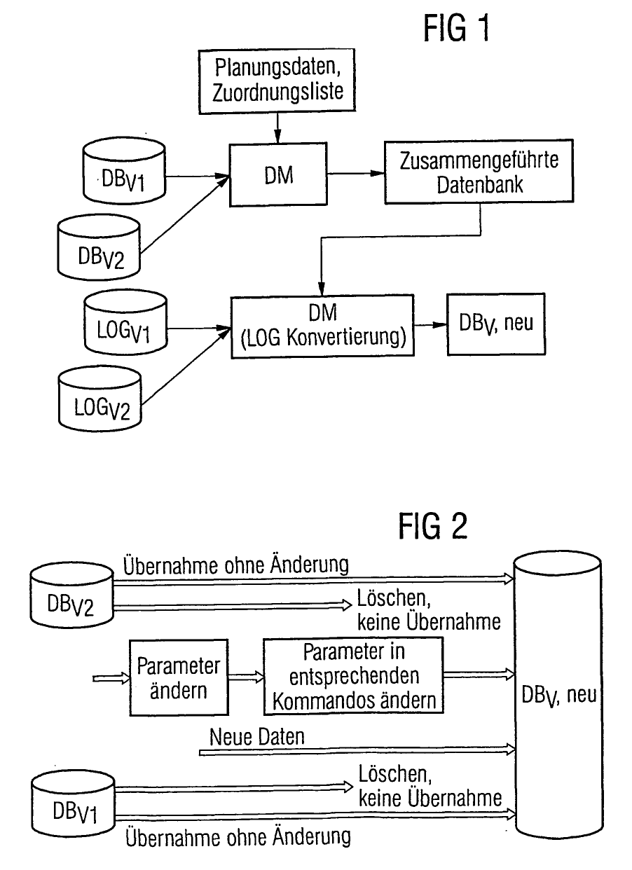

FIG. 1 shows a schematic representation of the execution sequence of the method according to the invention,

FIG. 2 shows a schematic representation of the possible operations when several databases DB_{V1}, DB_{V2} are merged to form a new database DB_{V,new}.

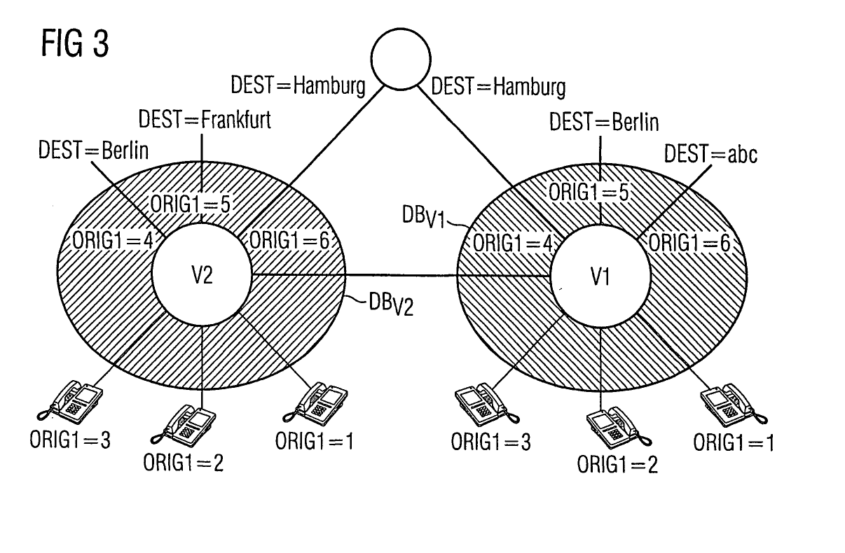

FIG. 3 shows a schematic representation of a network configuration with two exchanges V1 and V2 and

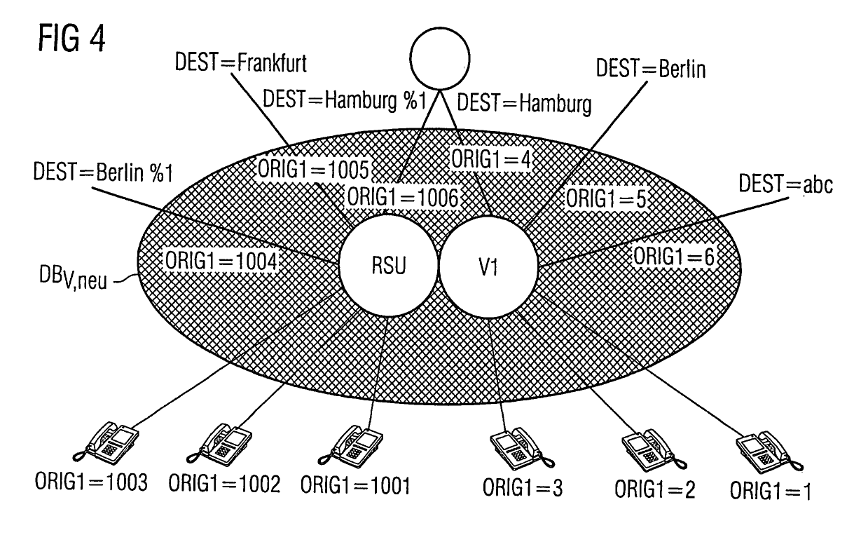

FIG. 4 shows a schematic representation of a network configuration with remote switching unit RSU and host exchange V.

The merging—migration—of two databases DB_{V1}, DB_{V2} is performed with the aid of an existing data extraction tool which extracts the data from the databases DB_{V1}, DB_{V2} in the form of so-called command files, and of an inventive data migration and upgrade tool DM which generates a uniform set of commands from the command files of the exchanges V1, V2. FIG. 1 represents this operation in schematic form.

All the relevant data of the exchanges V1, V2 is contained in the resulting set of commands. In the event of name conflicts, a list containing solution proposals is generated and taken into account together with the results list of a planning tool when the databases DB_{V1}, DB_{V2} are merged using the inventive data migration and upgrade tool DM.

When the command files are merged, the extracted data is handled differently—FIG. 2:

Data of the exchanges V1, V2 that is no longer valid is deleted.

Data of the exchanges V1, V2 that is still valid is incorporated without modifications into the merged database DB_{V,new}.

In order to achieve uniform addressing and numbering in the merged database DB_{V,new}, the data of the exchanges V1, V2 is modified according to specific rules when identical names or designations occur in both databases DB_{V1}, DB_{V2}. For example, the same name BERLIN in the database DB_{V1} of the exchange V1 remains unmodified and is inserted from the database DB_{V2} of the exchange V2 as BERLIN%1 into the new database DB_{V,new}. The modifications must be made in all commands which contain the modified names or designations as parameters.

Some commands are regenerated by the inventive data migration and upgrade tool DM.

Most commands are incorporated without modification into the merged database.

The resulting new database Downs is modified as required on the basis of the planning data.

After the original command files have been merged into a new command file, any modifications made in the interim to the databases DB_{V1}, DB_{V2} of the exchanges V1, V2—logged automatically in so-called LOG files LOG_{V1}, LOG_{V2}—are merged with the new command file following an appropriate conversion of the LOG files by the data migration and upgrade tool DM and the new database DB_{V,new}, of the host exchange V is created.

The solution of a problem arising during merging of the databases DB_{V1}, DB_{V2} of two exchanges V1, V2 will be illustrated with reference to an application example. The same origin identifier values (ORIG1) are used for the subscribers in the database DB_{V1} of the exchange V1 and also in the database DB_{V2} of the exchange V2 for different routes—FIG. 3. The merging of the two databases DB_{V1}, DB_{V2} can then lead to the following addressing problem for outgoing routes: for the subscribers of the exchange V1 a different route is provided for the same codepoint 040 (DEST=Hamburg) than for the subscribers in the exchange V2. Name conflicts of this kind are detected automatically when the databases DB_{V1}, DB_{V2} are merged and eliminated by renaming according to specific rules. In this example the names of the database DB_{V1} of the exchange V1 are transferred without modification and the names of the database DB_{V2} of the exchange V2 are modified before being transferred into the merged database DB_{V,new}.

The routing data is modified in the following steps:

The ORIG1 values are re-planned and assigned.

The name conflicts are resolved.

Codepoint databases are set up as a function of the ORIG1 values, including for codes which were previously created without ORIG1. Codepoints should be differentiated according to origin—exchange V1 or exchange V2.

The merged database DB_{V,new} is optimized, e.g. codepoints with identical code and different ORIG1 values are merged into the same destination DEST.

The result of the merging of the databases DB_{V1}, DB_{V2} of the exchanges V1, V2 is a consistent database DB_{V,new} for a host exchange V with remote switching unit RSU—FIG. 4.

1. Method for merging distributed databases which is used for databases (DB_{V1}, DB_{V2}) distributed over multiple components (V1, V2) of a data processing system,
according to which in a first step the databases (DB_{V1}, DB_{V2}) of the components (V1, V2) are extracted,
according to which in a second step the extracted databases (DB_{V1}, DB_{V2}) are merged outside of the data processing system in a new database (DB_{V,new}), whereby
data of the databases (DB_{V1}, DB_{V2}) that is no longer valid is deleted,
data of the databases (DB_{V1}, DB_{V2}) that is still valid is incorporated without modifications
according to which in a third step the new database (DB_{V,new}) is supplemented with the modifications made to the databases (LOG_{V1}, LOG_{V2}) of the components (V1, V2) during the processing time of the second step.

2. Method according to claim 1,
characterized in that
during the second step, in addition, name conflicts which result from previously identical designations in the databases (DB_{V1}, DB_{V2}) of the components (V1, V2) are resolved.

3. Method according to one of claims 1 or 2,
characterized in that
in the second step, in addition, planning data generated during a planning phase is incorporated into the resulting new database (DB_{V,new}).

4. Method according to one of claims 1 to 3,
characterized in that
initially only the first and the second step are performed,
the names resulting during the automatic resolution of the name conflicts are modified with the aid of the new database (DB_{V,new}) and in the process an assignment list is generated from the assignment of the automatically assigned names to the modified names.
the merging of the databases (DB_{V1}, DB_{V2}) is performed as described with incorporation of the assignment list.

5. Method according to one of claims 1 to 4,
characterized in that
the result of the merge is a plurality of distributed databases (DB_{V,new}).

6. Method according to one of claims 1 to 5,
characterized in that
the components (V1, V2) are exchanges.
